(19) United States
(12) Patent Application Publication
(10) Pub. No.: US 2007/0086355 A1
(43) Pub. Date: Apr. 19, 2007

(54) Data transmission apparatus for traffic control to maintain quality of service

(75) Inventors: Junichi Sawada, Kawasaki (JP); Tsuyoshi Matsumoto, Kawasaki (JP); Takenori Oshida, Kawasaki (JP); Kenichi Ishikawa, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/343,289

(22) Filed: Jan. 31, 2006

(30) Foreign Application Priority Data
Oct. 18, 2005 (JP) 2005-303528

(51) Int. Cl. H04J 1/16

(52) U.S. Cl. 370/252; 370/392

(57) ABSTRACT

A data transmission apparatus, which transmits data from a first communication line to a second communication line and performs a traffic priority control on the data, includes: a monitoring unit that monitors a condition of the second communication line; a storage unit that stores a plurality of tables each of which includes information for the traffic priority control; and a control unit that performs the traffic priority control using a table that is selected from among the tables based on the condition.

### CROSS-REFERENCE TO RELATED APPLICATIONS

This application is based upon and claims the benefit of priority from the prior Japanese Patent Application No.2005-303528, filed on Oct. 18, 2005, the entire contents of which are incorporated herein by reference.

### BACKGROUND OF THE INVENTION

1. Field of the Invention

The present invention relates to a data transmission apparatus that transmits data from a local area network (LAN) to a wide area network (WAN) and performs traffic control to maintain a quality of service (QoS).

2. Description of the Related Art

Conventionally, there has been suggested a router that connects a LAN to a WAN, and transmits data from the LAN to the WAN to achieve data communications between LANs over the WAN. There has been also suggested a router that detects the traffic between the LANs, calculates the bandwidth required for the data communications, and changes (increases or decreases) the number of physical lines, which functioning as a single logical line of high bandwidth (link aggregation), to be used for the data communications so that the calculated bandwidth is achieved (see, for example, Japanese Patent Application Laid-Open No. H6-334660).

Such a router, however, cannot perform a quality of service (QoS) control flexibly according to a change in the bandwidth of the logical line. That is, even when the bandwidth of the logical line decreases as one or some of the physical lines get out of service due to an error or other reasons, the router performs the control on the precondition that the logical line has the same bandwidth as before. As a result, the amount of data transmitted from the LAN to the WAN after the control can exceed a capacity of the actual bandwidth of the WAN. If an excessive amount of data is transmitted to the WAN, the control cannot be achieved properly, resulting in increased transmission delay or a packet missing.

### SUMMARY OF THE INVENTION

It is an object of the present invention to at least solve the above problems in the conventional technology.

A data transmission apparatus according to an aspect of the present invention, which transmits data from a first communication line to a second communication line and performs a traffic priority control on the data, includes: a monitoring unit that monitors a condition of the second communication line; a storage unit that stores a plurality of tables each of which includes information for the traffic priority control; and a control unit that performs the traffic priority control using a table that is selected from among the tables based on the condition.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a data transmission apparatus according to a first embodiment of the present invention;

FIGS. 2 and 3 are a schematic of a quality of service (QoS) table according to the first embodiment;

FIG. 4 is a flowchart of a QoS control according to the first embodiment;

FIGS. 5 and 6 are a schematic for illustrating the QoS control;

FIG. 7 is a block diagram of a data transmission apparatus according to a second embodiment of the present invention;

FIGS. 8 and 9 are a schematic of a QoS table according to the second embodiment;

FIG. 10 is a flowchart of a QoS control according to the second embodiment; and

FIGS. 11 and 12 are a schematic for illustrating the QoS control.

### DETAILED DESCRIPTION OF THE PREFERRED EMBODIMENTS

Exemplary embodiments of the present invention will be explained in detail with reference to the accompanying drawings.

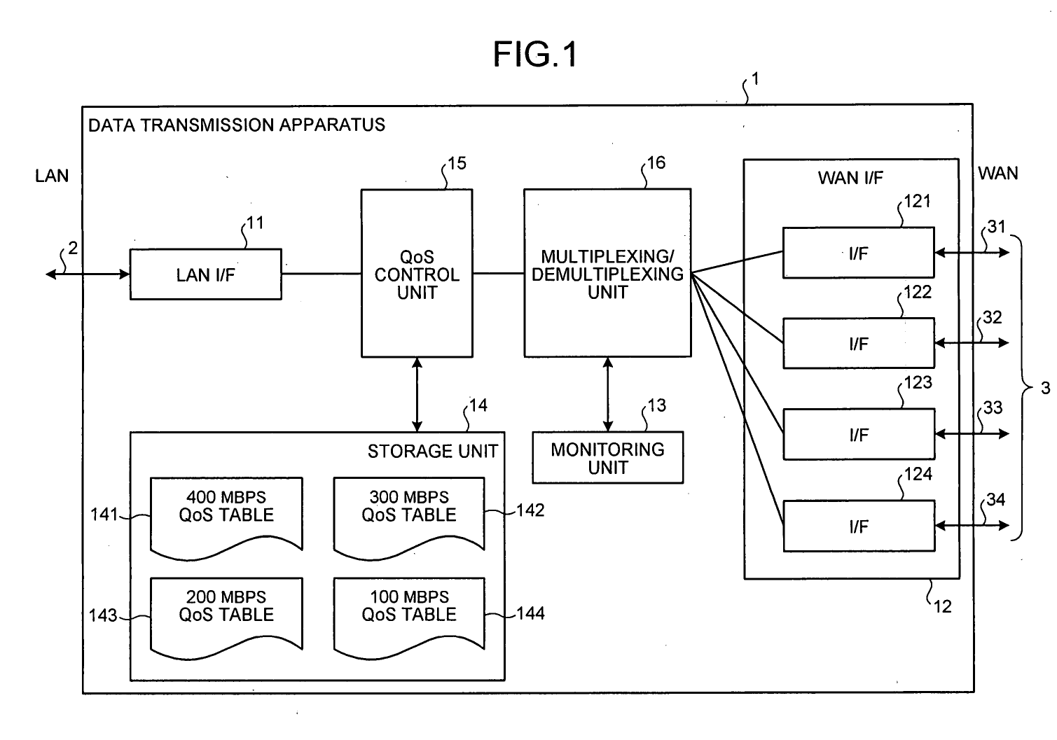

FIG. 1 is a block diagram of a data transmission apparatus according to a first embodiment of the present invention. As shown in FIG. 1, a data transmission apparatus 1 includes a local area network (LAN) interface 11, a wide area network (WAN) interface 12, a monitoring unit 13, a storage unit 14, a quality of service (QoS) control unit 15, and a multiplexing/demultiplexing unit 16.

The LAN interface 11 performs data communication through a line 2 in a LAN. When the LAN is Ethernet (registered trademark), an Ethernet interface is used as the LAN interface 11.

The WAN interface 12 performs data communication through a logical line 3 of a WAN, such as a public line, a packet network, and a lease line. The logical line 3 has a bandwidth of 400 Mbps and includes four physical lines 31, 32, 33, and 34 each of which having a bandwidth of 100 Mbps. The WAN interface 12 includes interfaces 121, 122, 123, and 124 that perform data communication through the physical lines 31, 32, 33, and 34, respectively. The monitoring unit 13 monitors a condition of the logical line 3 by monitoring the multiplexing/demultiplexing unit 16, and detects the current bandwidth of the logical line 3.

The storage unit 14 includes QoS tables 141, 142, 143, and 144. Each of the QoS tables 141, 142, 143, and 144 stores setting information for different bandwidth to perform a traffic priority control on data to be transmitted from the LAN to the WAN.

In the first embodiment, the bandwidth of the logical line 3 is: 400 mega bits per second (Mbps) when all of the physical lines 31, 32, 33, and 34 are in a normal condition; 300 Mbps when an error occurs in one of the physical lines; 200 Mbps when an error occurs in two of the physical lines; and 100 Mbps when an error occurs in three of the physical lines. Accordingly, the storage unit 14 stores four different QoS tables: a QoS table 141 for 400 Mbps, a QoS table 142 for 300 Mbps, a QoS table 143 for 200 Mbps, and a QoS table 144 for 100 Mbps.

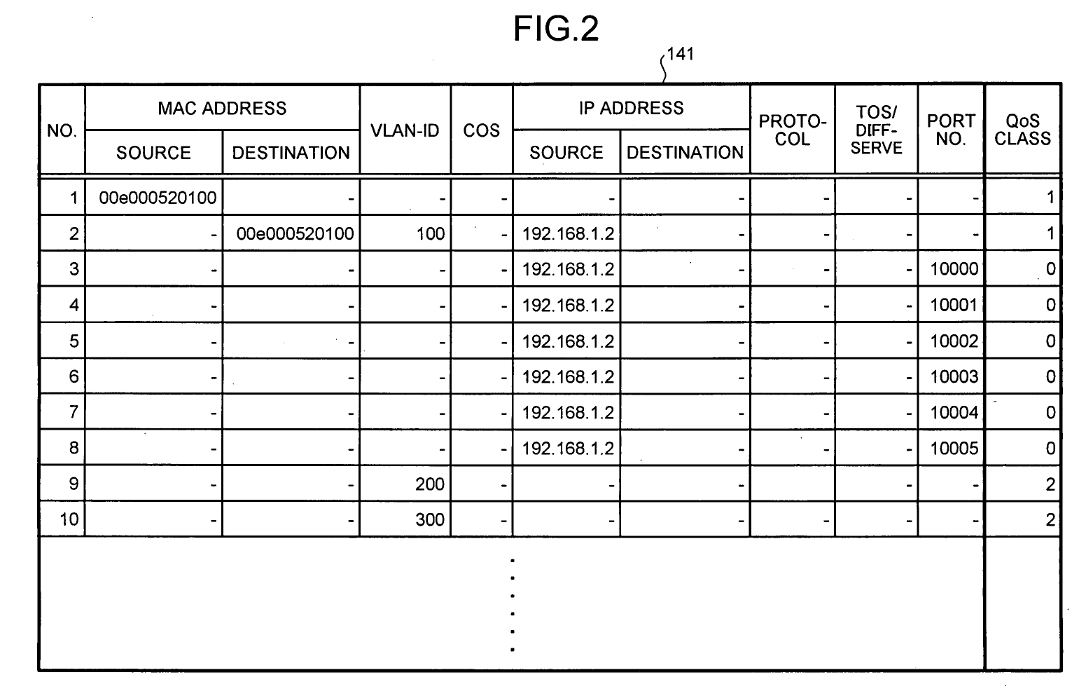

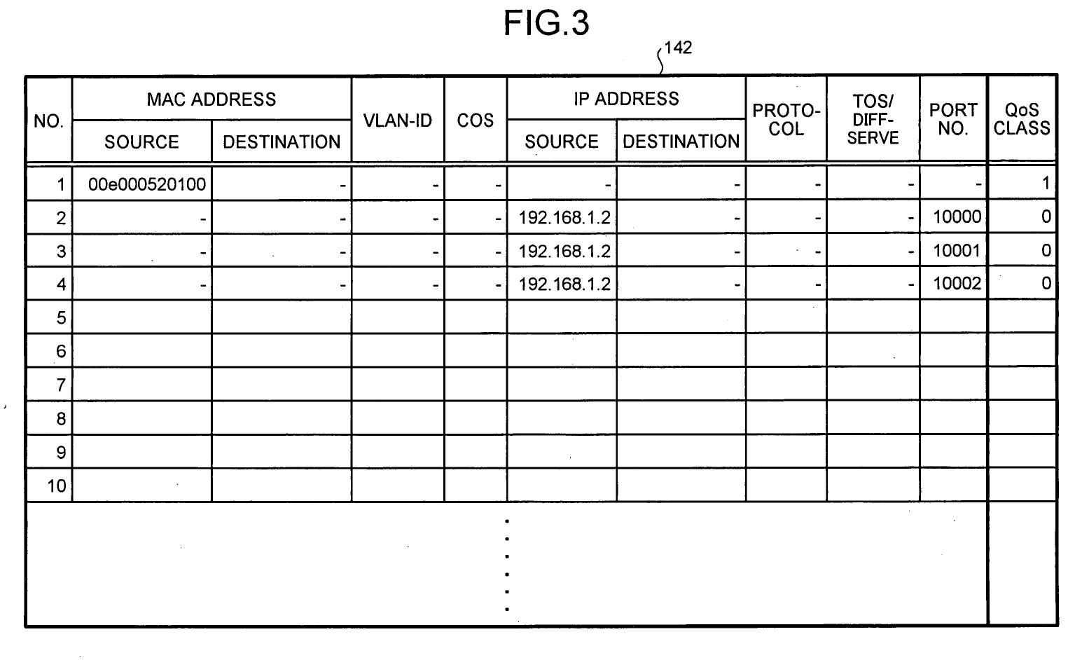

FIGS. 2 and 3 are schematics of the QoS table 141 and 142, respectively. A QoS class shown in FIGS. 2 and 3 indicates a traffic priority. For example, a class “0” indicates a high priority, a class “1” indicates a medium priority, and a class “2” indicates a low priority.

In the QoS table 141, values are set so that the total traffic becomes 400 Mbps. In the QoS table 142, values are set so that the total traffic becomes 300 Mbps. In the QoS tables 143 and 144, values are set in a similar manner.

The QoS control unit 15 selects a QoS table that corresponds to the current bandwidth of the logical line 3, which is detected by the monitoring unit 13, from among the QoS tables 141, 142, 143, and 144. Then, the QoS control unit 15 performs a priority control on data to be transmitted from the LAN to the WAN based on the setting information in the selected QoS table.

The multiplexing/demultiplexing unit 16 demultiplexes data input from the LAN interface 11 through the QoS control unit 15 to output to each of the physical lines of the WAN. Moreover, the multiplexing/demultiplexing unit 16 multiplexes data input from the interfaces 121, 122, 123, and 124 of the WAN interface 12 to input to the LAN interface 11 through the QoS control unit 15.

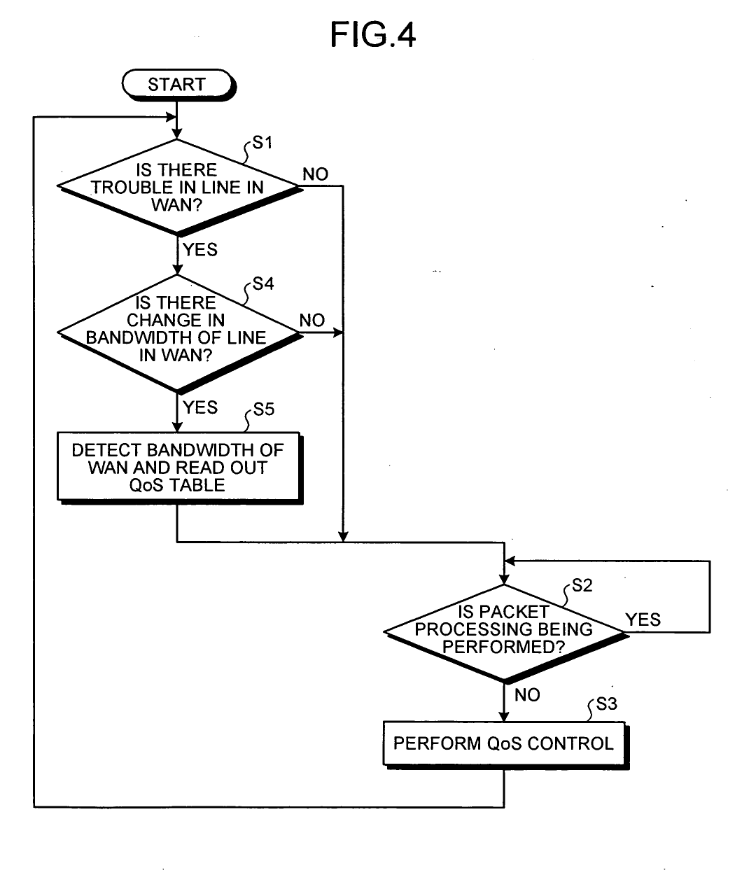

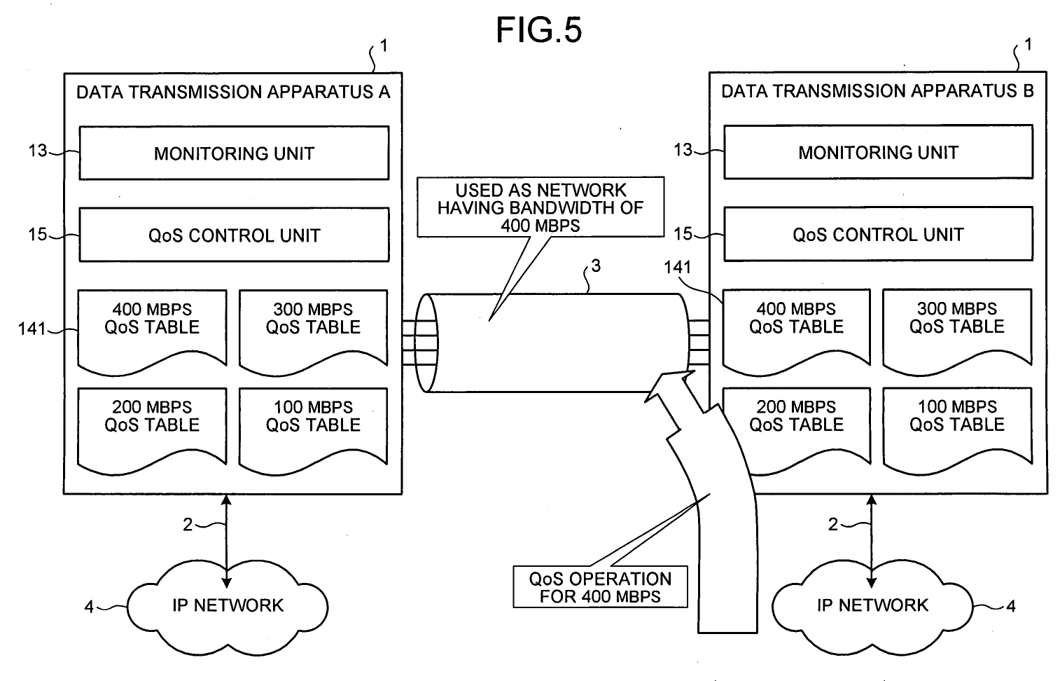

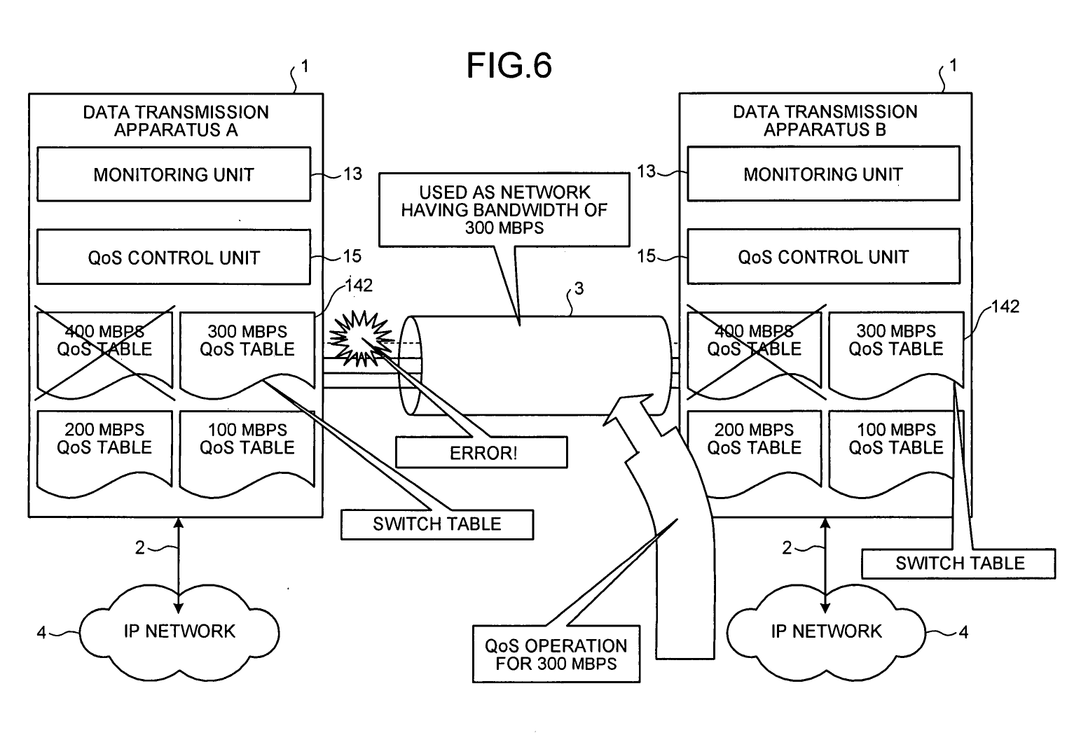

FIG. 4 is a flowchart of a QoS control performed by the data transmission apparatus 1. FIGS. 5 and 6 are schematics for illustrating the QoS control. Data transmission apparatuses A and B shown in FIGS. 5 and 6 are the same apparatus as the data transmission apparatus 1. An internet protocol (IP) network 4 shown in FIGS. 5 and 6 corresponds to the LAN described above.

The monitoring unit 13 monitors the logical line 3 all the time, and determines whether an error has occurred in the logical line 3 (step S1). When it is determined that no error has occurred (“NO” at step S1), the QoS control unit 15 determines whether a packet processing is being performed in the multiplexing/demultiplexing unit 16 (step S2).

When the packet processing is being performed (“YES” at step S2), the QoS control unit 15 waits until the processing is completed. When the packet processing is not being performed (“NO” at step S2), the QoS control unit 15 reads out the QoS table 141 for the bandwidth of 400 Mbps from the storage unit 14 to perform the QoS control based on the setting information in the QoS table 141 (step S3). Then, the process returns back to step S1.

When it is determined that an error has occurred in the logical line 3 (“YES” at step S1), the monitoring unit 13 calculates the bandwidth of the logical line 3, and determines whether the bandwidth has changed (step S4). When the bandwidth has not changed (“NO” at step S4), the process proceeds to step S2. FIG. 5 schematically illustrates the processing described above.

When it is determined that the bandwidth has changed (“YES” at step S4), the monitoring unit 13 informs the current bandwidth to the QoS control unit 15. For example, when one line of the four physical lines is in an improper condition, the bandwidth of the logical line 3 is 300 Mbps. Therefore, the monitoring unit 13 informs the QoS control unit 15 that the current bandwidth of the logical line 3 is 300 Mbps.

The QoS control unit 15 reads out a QoS table, for example, the QoS table 142 for the bandwidth of 300 Mbps, that corresponds to the current bandwidth informed by the monitoring unit 13 (step S5). Then, the QoS control unit 15 determines whether packet processing is being performed (step S2), and after the processing is completed (“NO” at step S2), the QoS control unit 15 performs the QoS control based on the setting information in the QoS table 142 (step S3). FIG. 6 schematically illustrates the processing described above. Then, the process returns back to step S1 to keep monitoring the logical line 3.

In the flowchart shown in FIG. 4, step S1 may be omitted. In such a case, the process of the QoS control starts from step S4, and the monitoring unit 13 only detects a change in the bandwidth of the logical line 3 without checking occurrence of an error.

According to the first embodiment, the QoS tables 141, 142, 143, and 144 corresponding to each possible bandwidth of the logical line 3 are stored in the data transmission apparatus 1, and the traffic priority control is performed using one of the QoS tables that correspond to an actual bandwidth of the logical line 3. Thus, even if the bandwidth of the logical line 3 has decreased due to an error occurred in the physical lines 31, 32, 33, and 34, data can be transmitted from the LAN to the WAN without causing a transmission delay or a packet missing.

The bandwidth of each physical line in a WAN may be various values, for example, 6 Mbps or 1.5 Mbps, without being limited to 100 Mbps as described in the first embodiment. Moreover, the bandwidth of each physical line may not be identical, and various physical lines of different bandwidths may be used in a mixed manner. For example, a physical line of 100 Mbps, a physical line of 6 Mbps, and a physical line of 1.5 Mbps can be grouped to form the logical line 3. The number of the physical lines is not limited to four, and may be two, three, five, or more. The data transmission apparatus 1 can be an IP converter that is connected to a link aggregation network, or other networks in which an available bandwidth in a WAN varies due to an error in a communication line or a package (PKG error).

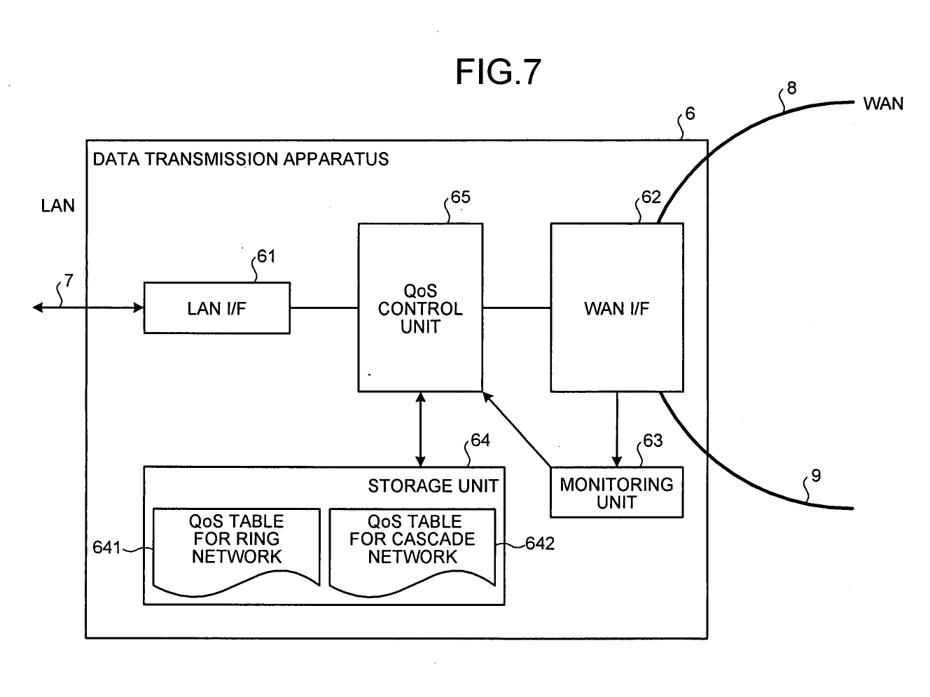

FIG. 7 is a block diagram of a data transmission apparatus according to a second embodiment of the present invention. As shown in FIG. 7, a data transmission apparatus 6 is a resilient-packet-ring (RPR) device that is connected to a ring-type network, and includes a LAN interface 61, a WAN interface 62, a monitoring unit 63, a storage unit 64, and a QoS control unit 65.

The LAN interface 61 performs data communication through a line 7 in a LAN. When the LAN is Ethernet, an Ethernet interface is used as the LAN interface 61.

The WAN interface 62 performs data communication through lines 8 and 9 in a WAN. The lines 8 and 9 form two communication routes in the ring-type network, that is, an inner ring (or downlink) and an outer ring (or uplink).

The monitoring unit 63 monitors a condition of the communication routes. The monitoring unit 63 detects a topology of the WAN. The WAN has a ring topology when both the communication routes are in normal condition, and has a cascade topology when an error occurs in at least one of the communication routes.

The storage unit 64 includes a QoS table 641 for a ring network and a QoS table 642 for a cascade network. The QoS table 641 stores setting information to perform a traffic priority control on data to be transmitted when the WAN is a ring network. The QoS table 642 stores setting information to perform a traffic priority control when the WAN is a cascade network.

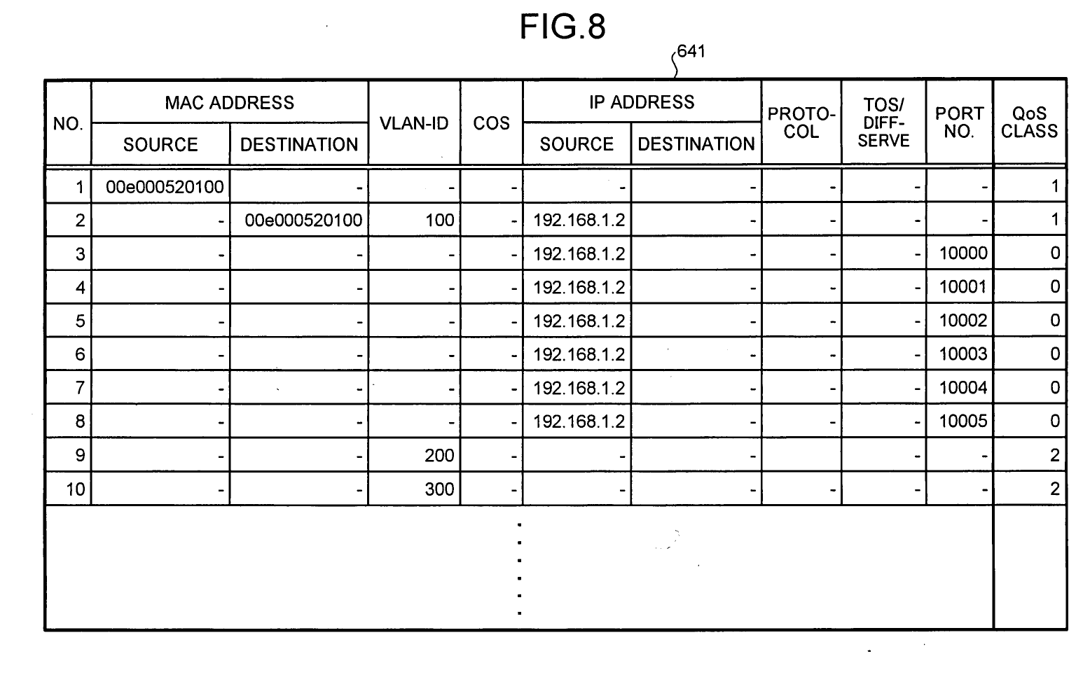

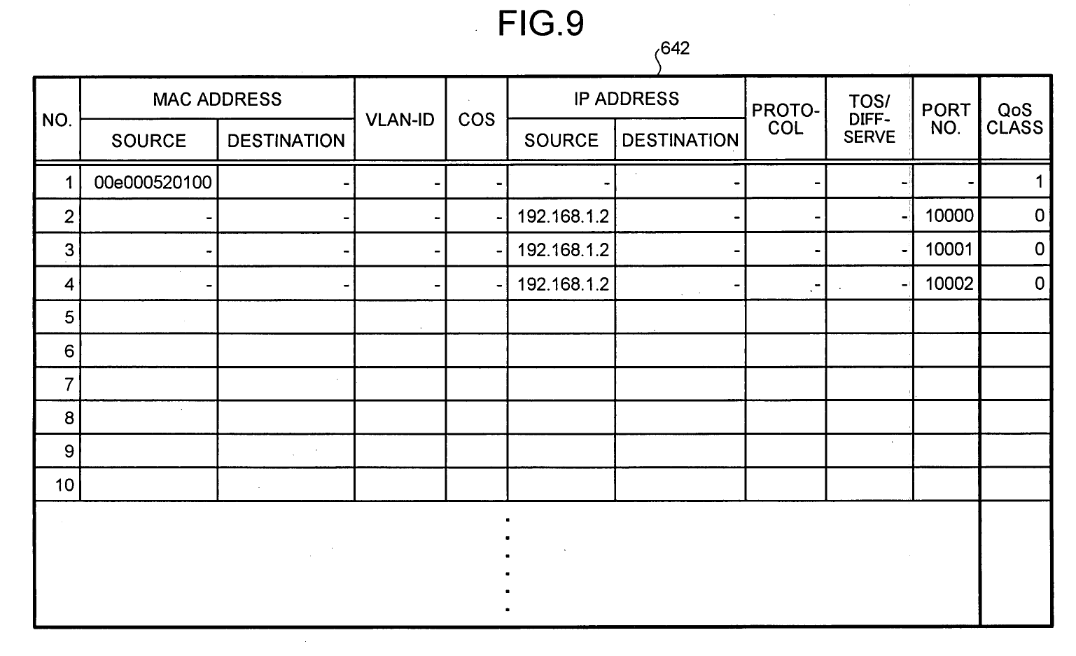

FIGS. 8 and 9 are schematics of the QoS tables 641 and 642, respectively. In the QoS table 641, values are set so that the total traffic becomes twice as much as the bandwidth of the WAN. In the QoS table 642, values are set so that the total traffic becomes equal to the bandwidth of the WAN.

The QoS control unit 65 selects a QoS table that corresponds to the topology of the WAN from among the QoS tables 641 and 642. Specifically, the QoS control unit 65 selects the QoS table 641 when the topology of WAN is a ring, and the QoS table 642 when the topology is a cascade. Then, the QoS control unit 65 performs a priority control on data to be transmitted from the LAN to the WAN based on the setting information in the selected QoS table.

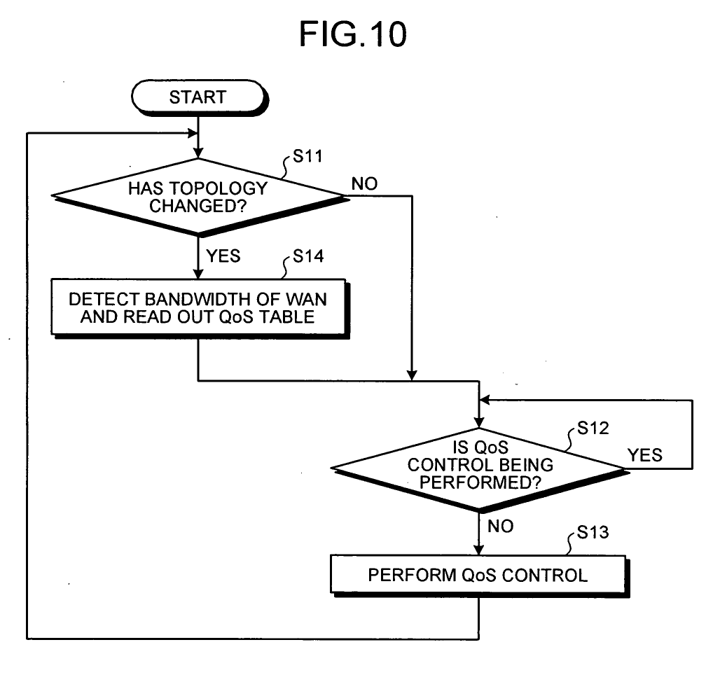

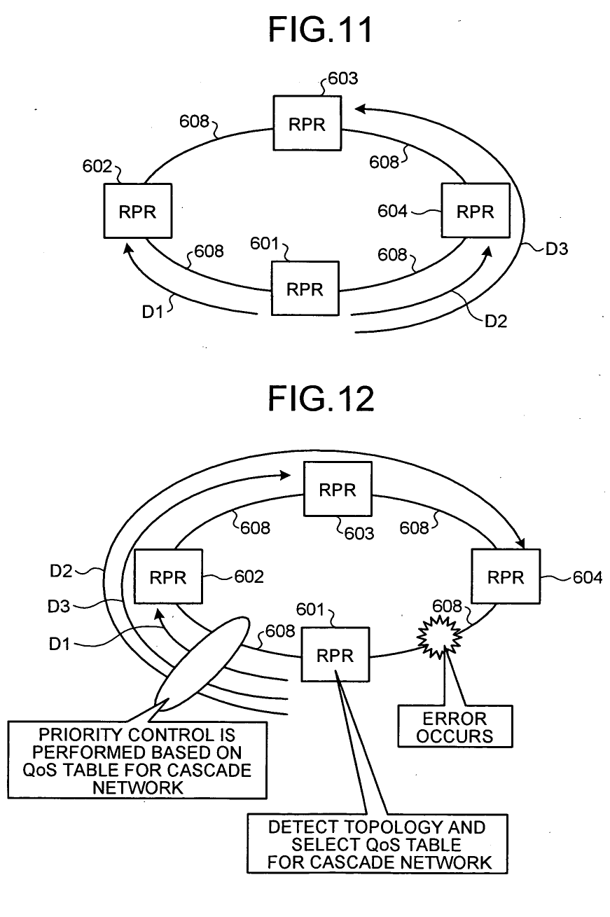

FIG. 10 is a flowchart of a QoS control performed by the data transmission apparatus 6. FIGS. 11 and 12 are schematics for illustrating the QoS control. As shown in FIGS. 11 and 12, four RPR devices 601, 602, 603, and 604 are connected to a ring-type WAN 608. Each of the RPR devices 601, 602, 603, and 604 is the data transmission apparatus 6.

The monitoring unit 63 monitors the WAN 608 all the time, and determines whether the topology of the WAN 608 has changed from the ring to the cascade (step S11). When the topology has not changed (“NO” at step S11), the QoS control unit 65 determines whether a QoS control is being performed (step S12).

When it is determined that a QoS control is being performed (“YES” at step S12), the QoS control unit 65 waits until the processing is completed. When it is determined that no QoS control is being performed (“NO” at step S12), the QoS control unit 65 reads out the QoS table 641 for ring topology from the storage unit 64 to perform the QoS control based on the setting information in the QoS table 641 (step S13). FIG. 11 illustrates the processing described above.

When it is determined that the topology of the WAN 608 has changed from the ring to the cascade (“YES” at step S11), the monitoring unit 63 calculates the bandwidth of the WAN 608, and informs the QoS control unit 65 of calculated bandwidth and the topology of the WAN 608 being the cascade. The QoS control unit 65 reads out the QoS table 642 for cascade topology, which corresponds to the current topology and the current bandwidth informed by the monitoring unit 63 (step S14).

The QoS control unit 65 determines whether a QoS control is being performed (step S12). After the QoS control is completed (“NO” at step S12), the QoS control unit 65 performs the QoS control based on the setting information in the QoS table 642 (step S13). Then, the process returns back to step S11 to keep monitoring a change in the topology.

In an example shown in FIG. 11, data traffic D1 flows from the RPR device 601 to the RPR device 602 in a clockwise direction. Data traffic D2 flows from the RPR device 601 to the RPR device 604 in a counterclockwise direction. Data traffic D3 flows from the RPR device 601 to the RPR device 603 via the RPR device 604 in the counterclockwise direction. A priority control is performed on the data traffics D1 to D3 based on the QoS table 641.

In an example shown in FIG. 12, data transmission cannot be performed between the RPR device 601 and the RPR device 604 due to an error occured between the RPR device 601 and the RPR device 604 in the WAN 608. As a result, similar to the data traffic D1 flowing from the RPR device 601 to the RPR device 602 in the clockwise direction, the data traffic D2 flows from the RPR device 601 to the RPR device 604 via the RPR devices 602 and 603 in the clockwise direction. The data traffic D3 flows from the RPR device 601 to the RPR device 603 via the RPR device 602 in the clockwise direction. A priority control is performed on the data traffics D1 to D3 based on the QoS table 642.

According to the second embodiment, both the QoS table 641 for a ring network and the QoS table 642 for a cascade network are stored in the data transmission apparatus 6, and a QoS table that corresponds to the current topology of the WAN is selected for the traffic control after the topology of the WAN has changed. Thus, when the topology of the WAN has changed from a ring to a cascade, in which only data transmission in one direction can be achieved, a traffic priority control appropriate for the cascade network can be performed based on the QoS table 642. Therefore, even if the topology of the WAN has changed, data can be transmitted from a LAN to a WAN without causing a transmission delay or a packet missing.

The present invention is not limited to the first embodiment and the second embodiment, and various modifications may be applied. For example, the QoS control unit may switch the QoS tables based on a retransmission rate, which is monitored by the monitoring unit, of packets retransmitted using a higher-level protocol. Alternatively, the QoS control unit may switch the QoS tables based on an error rate, which is monitored by the monitoring unit, of received packets.

Furthermore, the QoS control unit may switch the QoS tables based on a fluctuation, which is monitored by the monitoring unit, in time required for packets to be received by a receiver. Moreover, if the traffic in the WAN changes depending on a time, a date, or a day of a week, the QoS control unit may switch the QoS tables based on such information.

According to the embodiments described above, it is possible to perform a priority control on a data transmission from a LAN to a WAN according to a variable condition of lines in the WAN.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A data transmission apparatus that transmits data from a first communication line to a second communication line and performs a traffic priority control on the data, the data transmission apparatus comprising:
a monitoring unit that monitors a condition of the second communication line;
a storage unit that stores a plurality of tables each of which includes information for the traffic priority control; and
a control unit that performs the traffic priority control using a table that is selected from among the tables based on the condition.

2. The data transmission apparatus according to claim 1, wherein the second communication line includes a plurality of physical lines functioning as a single logical line.

3. The data transmission apparatus according to claim 2, wherein number of the tables is equal to number of the physical lines.

4. The data transmission apparatus according to claim 1, wherein each of the tables corresponds to a different bandwidth of the second communication line.

5. The data transmission apparatus according to claim 1, wherein the monitoring unit monitors a bandwidth of the second communication line as the condition.

6. The data transmission apparatus according to claim 1, wherein the first communication line and the second communication line form a network of which topology changes when an error occurs in the network.

7. The data transmission apparatus according to claim 6, wherein each of the tables corresponds to a different topology of the network.

8. The data transmission apparatus according to claim 6, wherein the monitoring unit monitors the condition that determines a topology of the network.

9. The data transmission apparatus according to claim 1, wherein the monitoring unit monitors a retransmission rate of the data as the condition.

10. The data transmission apparatus according to claim 1, wherein the monitoring unit monitors an error rate of the data as the condition.

11. The data transmission apparatus according to claim 1, wherein the monitoring unit monitors a fluctuation in time required for the data to be received by a receiver as the condition.

12. The data transmission apparatus according to claim 1, wherein performs the traffic priority control using a table selected based on any one of a time, a date, and a day of a week.
